(19) United States
(12) Patent Application Publication
(10) Pub. No.: US 2023/0219561 A1
(43) Pub. Date: Jul. 13, 2023

(54) VEHICLE STATE ESTIMATION AUGMENTING SENSOR DATA FOR VEHICLE CONTROL AND AUTONOMOUS DRIVING

(71) Applicant: Motional AD LLC, Boston, MA (US)

(72) Inventors: Ahmed H. EL-Shaer, Pittsburgh, PA (US); Yimeng Dong, Northville, MI (US); Ludong Sun, Pittsburgh, PA (US)

(21) Appl. No.: 17/647,147

(22) Filed: Jan. 5, 2022

(51) Int. Cl. B60W 30/045; B60W 40/112; B60W 50/00; B60W 60/00

(52) U.S. Cl. CPC B60W 30/045; B60W 40/112; B60W 50/0098; B60W 60/001; B60W 2050/0052; B60W 2510/20; B60W 2520/10; B60W 2520/12; B60W 2520/18; B60W 2520/125; B60W 2556/60

(57) ABSTRACT

Provided are methods for vehicle state estimation based on sensor data, which can include receiving the sensor data generated by one or more sensors, calculating a cornering stiffness value associated with the vehicle, predicting a lateral velocity value associated with the vehicle based on the cornering stiffness value, and outputting a set of vehicle state variables indicative of a current state of the vehicle at least by inputting the lateral velocity value into a recursive filter. Some methods described also include updating the cornering stiffness value based on the set of vehicle state variables, updating the lateral velocity value based on the updated cornering stiffness value, and updating the set of vehicle state variables based on the updated lateral velocity value. Systems and computer program products are also provided.

### BACKGROUND

A self-driving vehicle needs to be able to determine or estimate the current vehicle state, such as accelerations and velocities, so that it can properly control itself. However, such a vehicle may include only a limited number of sensors, for various reasons including cost, complexity, weight, and the like. Thus, accurately determining or estimating the current vehicle state of such a self-driving vehicle can be challenging.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5A is a block diagram illustrating an example of a signal processing system;

FIG. 5B is a more detailed block diagram illustrating the signal processing system of FIG. 5A;

FIG. 6A is an illustration of an example of a signal convention used for vehicle state estimation;

FIG. 6B is an illustration of an example of a signal convention used for longitudinal velocity prediction;

FIG. 6C is an illustration of an example of a signal convention used for cornering stiffness estimation;

FIG. 7 is a data flow diagram illustrating an example of a signal processing operation; and

FIG. 8 is a flowchart of a process for vehicle state estimation based on sensor data.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a signal processing system that receives sensor data generated by one or more sensors provided on a vehicle. The sensor data can be used by the signal processing system to calculate certain parameters such as the cornering stiffness values (e.g., the ability of a tire to resist deformation in its shape while the vehicle corners, or more specifically, the slope of the curve for lateral force versus tire side-slip angle, as described in greater detail below) that can be used to predict the lateral velocity of the vehicle. Using the calculated parameters, the signal processing system can predict the lateral velocity of the vehicle and output a set of vehicle state variables indicative of a current state of the vehicle by inputting the predicted lateral velocity value into a recursive filter (e.g., a Kalman filter representing the kinematic model of a vehicle).

By virtue of the implementation of systems, methods, and computer program products described herein, techniques for vehicle state estimation based on sensor data according to embodiments of the present disclosure allow accurate vehicle state estimation to be performed without the use of high-precision GPS sensors or other sensors that may be cost prohibitive for autonomous vehicles or other consumer vehicles. These techniques can improve the accuracy of the prediction and estimation of various vehicle dynamics state variables while keeping the manufacturing costs down due to not having to use expensive GPS sensors. By doing so, the system described in the present disclosure can achieve improvements in the performance of other layers in the AV stack such as the prediction system (e.g., configured to determine a prediction associated with the vehicle), the planning system (e.g., configured to generate a route associated with the vehicle), the control system (e.g., control the movement or other operations associated with the vehicle), and the like.

As will be appreciated by one of skill in the art in light of the present disclosure, the embodiments disclosed herein improve the ability of automotive systems, and other nonautomotive vehicle systems, to provide mechanisms for predicting and estimating various vehicle dynamics state variables more accurately without having to use expensive GPS sensors. Prior techniques for accurately determining vehicle dynamics state variables such as the lateral velocity involved utilizing expensive and complex GPS sensors. However, as discussed above, such approaches may be prohibitively expensive and complex for automotive vehicles or other consumer vehicles.

In contrast, embodiments of the present disclosure utilize IMU and other sensors that are typically included in vehicle systems to perform accurate predictions and estimations of vehicle state variables, without using expensive GPS sensors. By doing so, the vehicle state estimation techniques described herein may improve the performance of the autonomous vehicle systems and vehicle systems in general, while keeping the manufacturing costs and complexities down.

The presently disclosed embodiments therefore address technical challenges inherent within autonomous vehicle systems, such as predicting and estimating more accurate vehicle state variables without increasing the manufacturing costs. These technical problems are addressed by the various technical solutions described herein, including predicting lateral velocities using tire cornering stiffness values, updating the tire cornering stiffness values, and feeding the updated tire cornering stiffness values back to the lateral velocity prediction process to compute updated lateral velocity predictions. Thus, the present disclosure represents an improvement on existing autonomous vehicle systems, and vehicle systems in general.

### Example Environment for Vehicles with Autonomous Systems

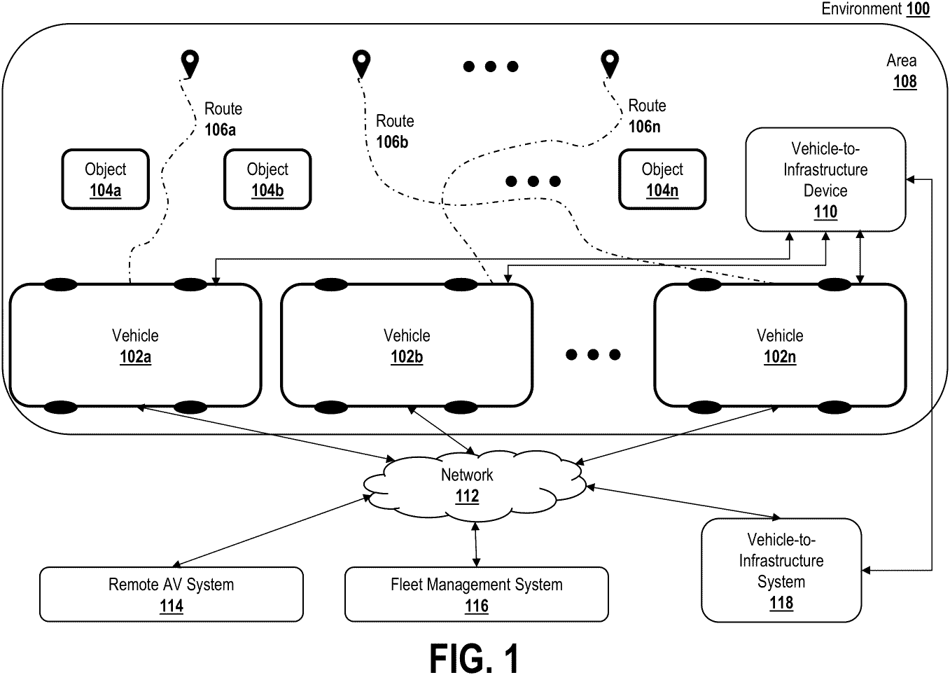

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

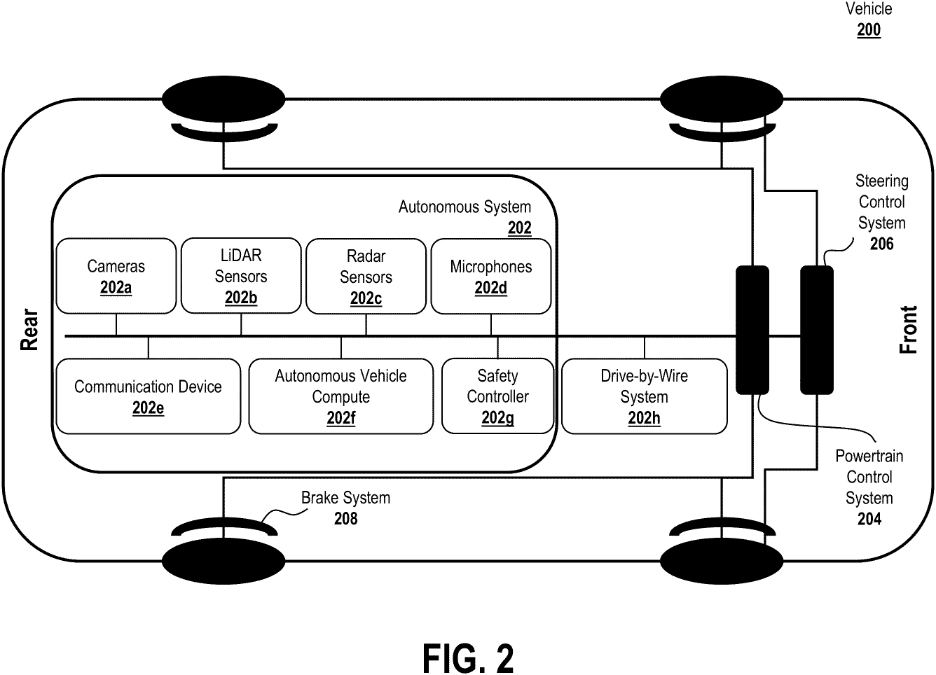

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g., a subspace of acceptable states (e.g., terminal states)). In some embodiments, the first state or region (e.g., initial state) includes a location at which an individual or individuals are to be picked up by the AV and the second state or region (e.g., the final goal state) includes a location or locations at which the individual or individuals picked up by the AV are to be dropped off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high-level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples, area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments, V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber opticbased network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International’s standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

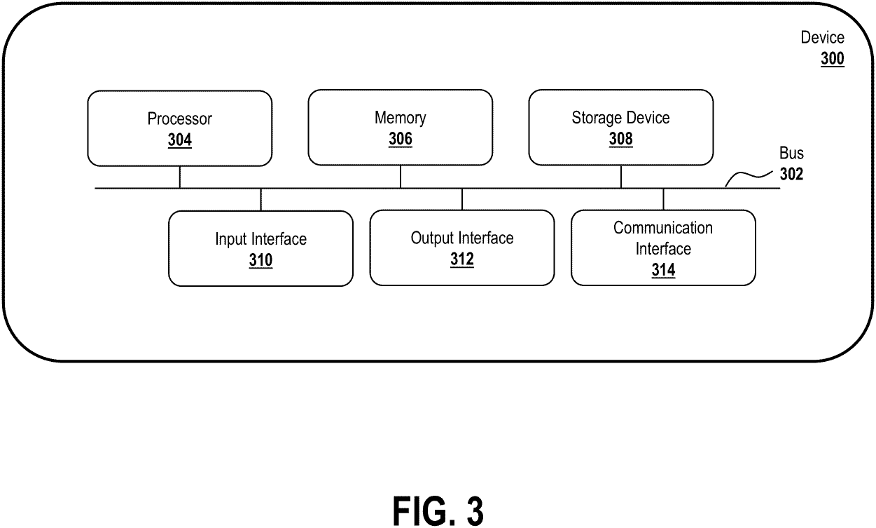

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid-state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally, or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

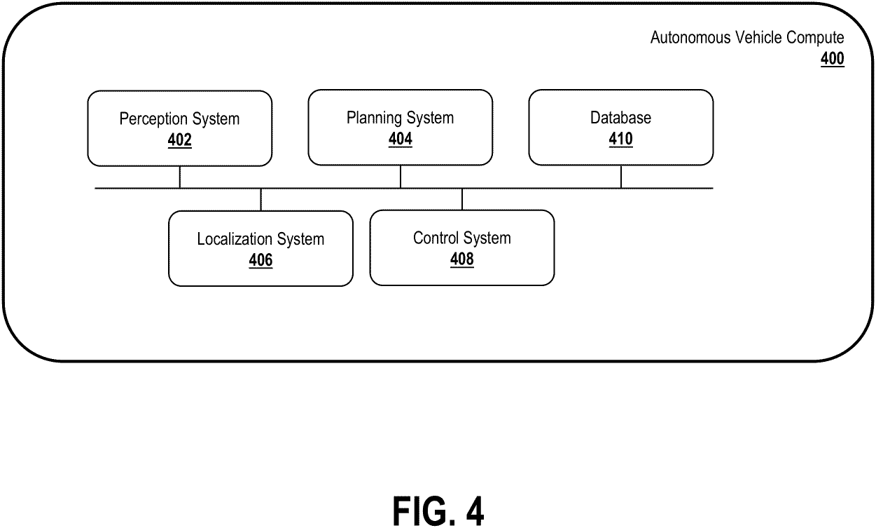

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

### Estimating Vehicle State Variables Based on Sensor Data

An autonomous vehicle system typically uses various vehicle state variables to describe the current state of the vehicle and to allow other layers in the autonomous vehicle stack to perform their respective tasks. One mechanism that can be used to determine such vehicle state variables is a high-precision GPS sensor. Such a GPS sensor can generate vehicle state variables such as the lateral velocities with a high degree of accuracy. However, such a GPS sensor can cost tens of thousands of dollars, making it impractical for use in everyday vehicles.

To address this issue, a signal processing system that can use the sensor data generated by the IMU and other sensors on the vehicle to estimate the vehicle state variables without the use of such GPS sensors. More specifically, the signal processing system includes a lateral velocity predictor in communication with a cornering stiffness estimator that periodically updates the cornering stiffness values used by the lateral velocity predictor to calculate the lateral velocity. The lateral velocity is then fed into a Kalman filter, which outputs the vehicle state variables.

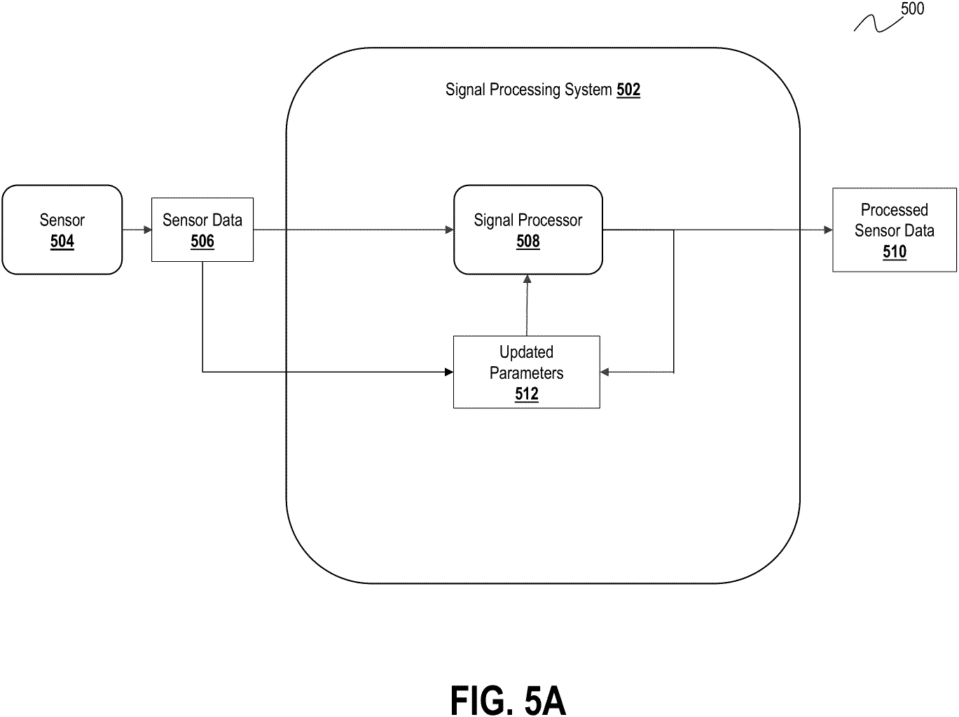

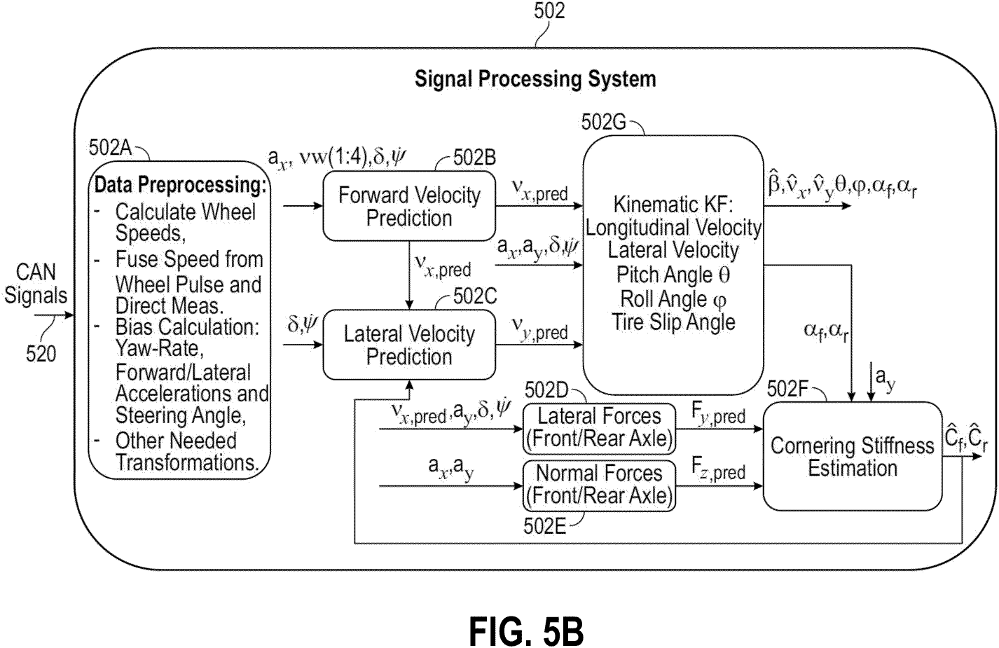

Some of the advantages of these techniques include improved accuracy in the prediction and estimation of various state variables using IMU sensor data without having to rely on more expensive GPS sensors. More accurate vehicle state variable prediction and estimation can lead to improvements in the performance of other layers in the AV stack such as the prediction system and the planning system. These techniques are described in greater detail below with reference to FIGS. 5A, 5B, 6A-6C, 7, and 8.

### Signal Processing Environment

FIG. 5A is a block diagram illustrating an example of a signal processing environment 500. In the illustrated example, the signal processing environment 500 includes a signal processing system 502 communicatively coupled with a sensor 504. In some embodiments, sensor 504 may be the same as, or similar to, sensors 202a-202d in FIG. 2 and/or input interfaces 310 in FIG. 3. In some cases, the signal processing environment 500 and/or the signal processing system 502 can form at least a part of the perception system 402, described herein at least with reference to FIG. 4.

The sensor 504 generates sensor data 506 and communicates the sensor data 506 to the signal processing system 502. The sensor 504 can include any one or any combination of an inertial measurement unit (IMU), a wheel speed sensor, a steering angle sensor, and the like. Similarly, the sensor data 506 can include different types of sensor data, such as forward and lateral accelerations, yaw rate, etc. In some embodiments, the sensor data 506 includes any one or any combination of an acceleration along the x-axis (also referred to herein as forward acceleration), an acceleration along the y-axis (also referred to herein as lateral acceleration), an acceleration along the z-axis, roll rate, pitch rate, and yaw rate.

In some embodiments, the signal processing system 502 may obtain the sensor data 506 from a different component other than the sensor 504. Further, the one or more sensors 504 and/or a different component can perform preliminary signal processing to modify the sensor data 506 prior to the signal processing system 502 obtaining the sensor data 506.

The signal processing system 502 includes a signal processor 508 configured to process the sensor data 506. The signal processor 508 can perform a variety of signal processing tasks on the sensor data 506. In some embodiments, the signal processor 508 may do so based on or using one or more updated parameters 512, one or more default parameters, or other parameters available to the signal processor 508. For example, the signal processor 508 can predict or estimate one or more vehicle state variables based on or using the sensor data 506, other parameters, and/or any equations or filters, and output the predicted or estimated variables as processed sensor data 510.

It will be understood that the signal processing system 502 can include fewer, more, or different components. For example, the signal processing system 502 can include multiple signal processors 508 performing different processing function on the sensor data 506 and/or processing sensor data 506 from different sensors 504.

The signal processor 508 can also generate updated parameters 512, which may include updated versions of the one or more parameters, variables, or values used by the signal processor 508 to generate the data included in the processed sensor data 510. The signal processor 508 can then use the updated parameters 512 to generate updated processed sensor data 510. For example, the updated parameters 512 may include cornering stiffness values, which can be used to predict or estimate the lateral velocity of the vehicle. In such an example, after updating the cornering stiffness values, the signal processor 508 may further update the lateral velocity based on the updated cornering stiffness values.

In some embodiments, the signal processor 508 periodically generates the updated parameters 512 (e.g., every minute, hour, day, week, month, or some other predefined period). In other embodiments, the signal processor 508 generates the updated parameters 512 upon detecting a change to the information used to generate the current version of the updated parameters 512. As an example, the signal processor 508 may generate updated values for the cornering stiffness when updated values of lateral and/or normal forces are available to the signal processor 508 (see FIG. 5B). By continuously updating the parameters used for prediction and/or estimation of vehicle state variables, the signal processor 508 can improve the accuracy of the vehicle state variables outputted to one or more other systems in the environment (e.g., environment 100) as processed sensor data 510. The operations of the signal processor 508 (and the signal processing system 502) are described in greater detail below with reference to FIG. 5B.

### Detailed Description of Signal Processing System

FIG. 5B is a more detailed block diagram illustrating the signal processing system of FIG. 5A according to some embodiments. In the illustrated example, the signal processing system 502 receives controller area network (CAN) signals 520 (also referred to herein as CAN bus signals) and includes data pre-processing block 502A, forward velocity prediction block 502B, lateral velocity prediction block 502C, lateral forces prediction block 502D, normal forces prediction block 502E, cornering stiffness estimation block 502F, and kinematic filter block 502G (also collectively referred to as blocks 502). Although not shown in FIG. 5B, the signal processing system 502 can output one or more of the estimated or predicted vehicle state variables (e.g., any combination of the variables indicated as being outputted by blocks 502F and 502G) to one or more other systems of the vehicle (e.g., those illustrated in FIG. 4).

### CAN Bus Signals

The CAN signals 520 may include inertial measurement unit (IMU) sensor data indicating forward and lateral accelerations, yaw rate, and the like, wheel/tire speed sensor data indicating the wheel/tire speed(s), steering angle sensor data indicating the steering angle, and the like (including any other signal or value described herein).

### Data Pre-Processing

At the data pre-processing block 502A, the signal processing system 502 preprocesses the CAN signals 520 for use by the blocks 502 illustrated in FIG. 5B.

One pre-processing that may be performed by the signal processing system 502 is bias removal (or bias reduction). For example, the IMU may not always be located at the center of gravity (“CG”) of the vehicle, whose exact location may change depending on the distribution of the weight of the passenger(s) and/or cargo. This may in some cases make straight use of the IMU sensor data not as reliable. Additionally, an IMU may have a built-in bias (e.g., due to imperfections in the components used for the IMU) that may need to be corrected (e.g., non-zero acceleration value when the vehicle is not moving). In addition to bias removal, the signal processing system 502 may also perform various signal fusion (e.g., fuse wheel speeds to predict vehicle longitudinal velocity), signal transformation (e.g., Equation (1) below), and the like.

One approach to bias determination and removal includes using “ground truth” data collected under high acceleration, medium-to-high vehicle forward velocity and relatively abrupt steering input on a test vehicle and validating the vehicle’s built-in IMU bias with respect to the ground truth data. An example experimental setup may include a test vehicle equipped with an IMU and a GPS sensor (e.g., a RT3000 model Global navigation satellite system (GNSS) and Inertial Navigation System (INS) manufactured by Oxford Technical Solutions Ltd.), a high coefficient of friction (“high-mu”) road surface for driving the test vehicle (e.g., an auto racing track), and multiple driving cycle data sets (e.g., 5 sets) collected from driving the test vehicle on the road surface.

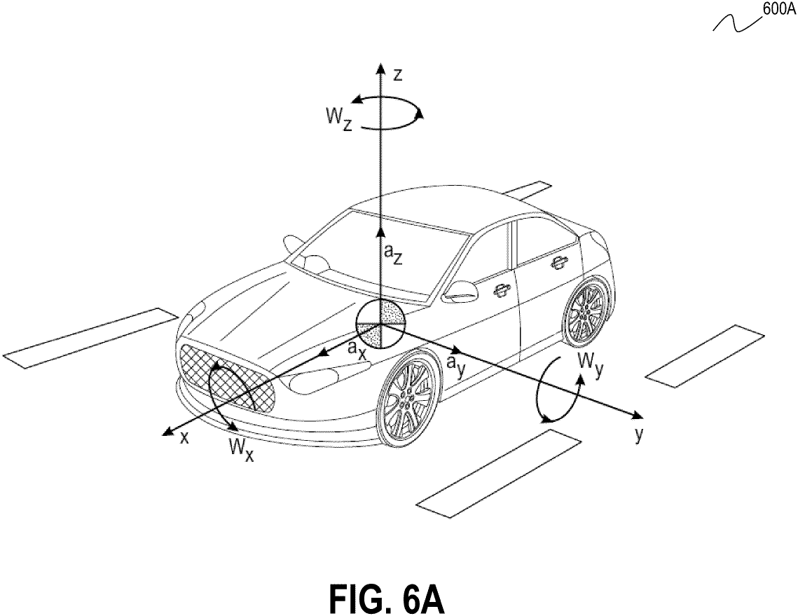

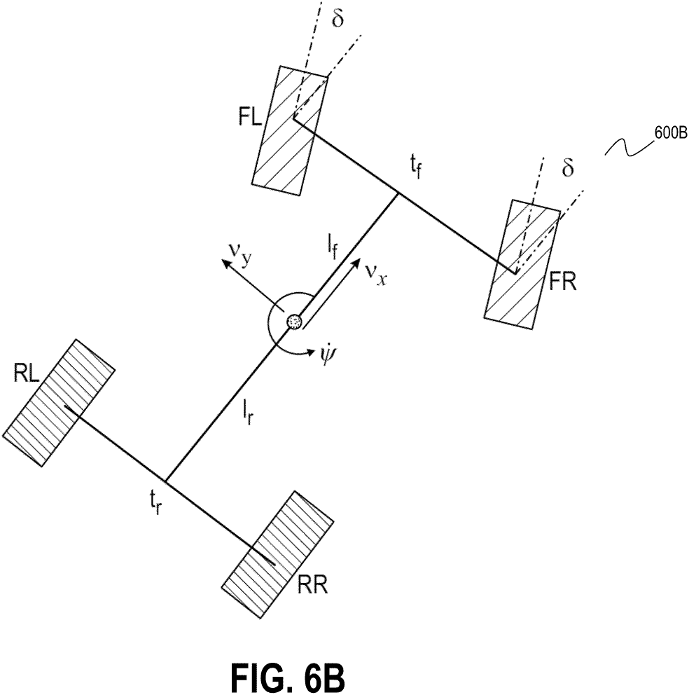

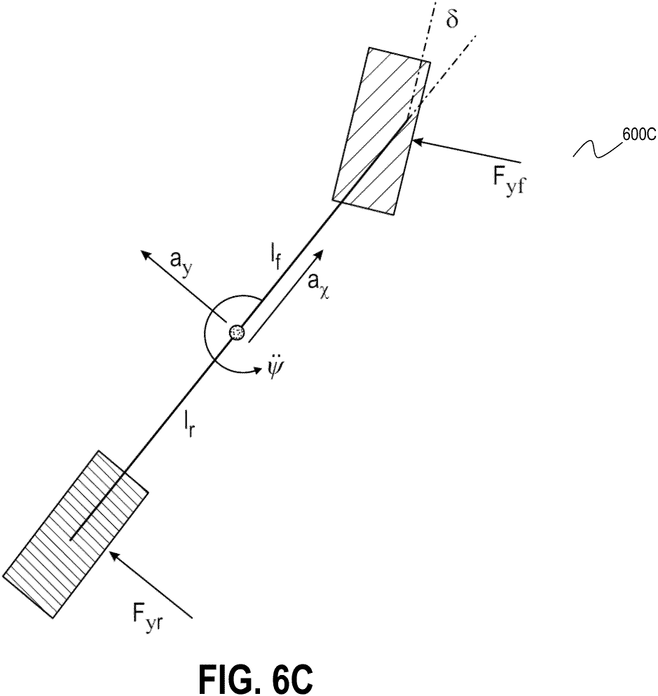

In the example experimental setup, the following relations are used for collecting the GPS sensor data sets (according to the convention illustrated in FIGS. 6A-6C and defined in Table 1 below):

$$\begin{matrix}{v}_{y} \left(C G\right) = {v}_{y} \left(G P S\right) + d x \left(\dot{ψ}\right) \\ {a}_{x} \left(C G\right) = {a}_{y} \left(G P S\right) + d x \left({\dot{ψ}}^{2}\right) \\ {a}_{y} \left(C G\right) = {a}_{y} \left(G P S\right) + d x \left(\ddot{ψ}\right)\end{matrix}$$

where v_{y}(CG), aₓ(CG), and a_{y}(CG) represent the GPS measurements v_{y}(GPS), aₓ(GPS), and a_{y}(GPS) reflected onto the center of gravity (CG) of the test vehicle, and dx representing the offset distance between the vehicle’s CG and the location of the GPS sensor along the longitudinal axis (x-axis).

FIG. 6A is an illustration of an example of a signal convention used for vehicle state estimation. As shown in FIG. 6A, the x-axis of the signal convention is provided along the forward direction of the vehicle, the y-axis of the signal convention is provided along the lateral direction of the vehicle, and the z-axis of the signal convention is provided along the direction perpendicular to both the forward direction and the lateral direction of the vehicle. FIG. 6A also shows angular velocity ωₓ about the x-axis, angular velocity ω_{y} about the y-axis, and angular velocity ω_{z} about the z-axis.

Additionally, a list of variables used herein and their definitions are provided in Table 1 below:

TABLE 1

List of variables and definitions

| | |
|---|---|
| νₓ / aₓ | forward velocity / acceleration |
| ν_{y} / a_{y} | lateral velocity / acceleration |
| ψ | yaw rate |
| δ | steering angle (at road-tire) |
| β | side-slip angle |
| θ / φ | pitch angle / roll angle |
| C_{ƒ} / Cᵣ | front / rear tire cornering stiffness |
| α_{ƒ} / αᵣ | front / rear tire side-slip angle |

In some embodiments, by determining the difference between the GPS measurements and the IMU measurements, the signal processing system 502 calculates and removes (or reduces) the bias in the IMU in the data pre-processing block 502A. For example, the bias in the lateral acceleration or the forward acceleration can be calculated using the following equation:

$$b i a s : = \left|{a}_{G P S} - {a}_{I M U}\right)$$

In order to reduce or minimize the effects of noise, a low pass filter may be used on the calculated bias value as follows:

$$b i a {s}_{f i l t} \left(k\right) = λ b i a {s}_{f i l t} \left(k - 1\right) + \left(1 - λ\right) b i a s \left(k\right)$$

In Equation (3), k represents the current sample time instant, k-1 represents the previous sample time instant, bias() represents the raw bias computation function including noise, and bias_filt() represents the filtered bias computation function, which does not include at least some of the noise included in bias() (thereby smoothening the bias computation).

In other embodiments, the signal processing system 502 determines the bias using predetermined conditions (e.g., by zeroing out nonzero trends or nonzero constant values in the IMU when the vehicle is in a standstill or slow motion) without relying on a GPS sensor. In such embodiments, the bias reduction or removal is performed using live data.

### Forward Velocity Prediction

At the forward velocity prediction block 502B, the signal processing system 502 computes a predicted value of the vehicle forward velocity (also referred to as longitudinal velocity) to feedforward into the vehicle dynamics state estimation (e.g., velocity estimation performed by the kinematic filter block 502G). The wheels’ rotational rates are the main source of information on the vehicle longitudinal velocity. Thus, in some embodiments, the signal processing system 502 (e.g., at the data pre-processing block 502A as shown in FIG. 5B) computes the equivalent linear wheel velocities (V_{FL}, V_{FR}, V_{RL}, V_{RR}, which are illustrated as vw(1:4) in FIG. 5B) by multiplying the wheel angular rates, measured using encoders, by a constant rolling radius.

However, wheels tend to slip longitudinally during acceleration and braking. Moreover, when the front wheels are steered, their longitudinal direction is not aligned with the vehicle and the yaw rate adds an additional term. Thus, in some embodiments, modified velocity values may be calculated as follows:

$$\begin{matrix}{V}_{F L} = {V}_{F L}^{m e a s} c o s \left(δ\right) - {ω}_{z} \frac{L}{2} & {V}_{F R} = {V}_{F R}^{m e a s} c o s \left(δ\right) + {ω}_{z} \frac{L}{2} \\ {V}_{H L} = {V}_{H L}^{m e a s} - {ω}_{z} \frac{L}{2} & {V}_{R R} = {V}_{R R}^{m e a s} + {ω}_{z} \frac{L}{2}\end{matrix}$$

where V_meas_FL, V_meas_FR, V_meas_RL, and V_meas_RR are the measured equivalent linear velocities of the wheels, and L is the distance between the two rear wheels (or the two front wheels).

FIG. 6B is an illustration of an example of a signal convention used for longitudinal velocity prediction. According to this signal convention, the four wheel speeds (V_{FL}, V_{FR}, V_{RL}, V_{RR}) can be used to express the vehicle forward velocity as follows:

$${v}_{x}^{\left(1\right)} = {v}_{F L} c o s \left(δ\right) + \frac{{t}_{f}}{2} \dot{ψ}$$

$${v}_{x}^{\left(2\right)} = {v}_{F R} c o s \left(δ\right) - \frac{{t}_{f}}{2} \dot{ψ}$$

$${v}_{x}^{\left(3\right)} = {v}_{R R} - \frac{{t}_{r}}{2} \dot{ψ}$$

$${υ}_{x}^{\left(4\right)} = {υ}_{R L} + \frac{{t}_{r}}{2} \dot{ψ}$$

These expressions can be fused as a weighted sum using radial-basis functions to obtain the prediction for the forward velocity at the CG as shown below:

$${υ}_{x}^{C G} \left(t\right) = \frac{1}{{\sum }_{i} {w}_{i} \left(t\right)} {\sum }_{i} {w}_{i} \left(t\right) {υ}_{x}^{\left(i\right)} \left(t\right) , i = 1 , 2 , 3 , 4$$

where,

$${w}_{i} \left(t\right) = e x p \left\{- \frac{1}{2} \left(\frac{{\left({a}_{x} - \frac{d {υ}_{x}^{\left(i\right)}}{d t}\right)}^{2}}{{σ}_{a x}^{2}} + \frac{{\left({υ}_{x}^{C G} \left(k - 1\right) - {υ}_{x}^{\left(i\right)}\right)}^{2}}{{\left({σ}_{υ x}^{\left(i\right)}\right)}^{2}}\right)\right\}$$

In Equation (4.3),

$${υ}_{x}^{C G} \left(k - 1\right)$$

is the previous sample value of the predicted forward velocity, and

$$\frac{d {υ}_{x}^{\left(i\right)}}{d l} \approx {\frac{{υ}_{x}^{\left(i\right)} \left(k\right) - {υ}_{x}^{\left(i\right)} \left(k - 1\right)}{{T}_{8}}}_{.}$$

Additionally, the parameters σ_{αχ} and

$${σ}_{v x}^{\left(i\right)}$$

(4 values) are tunable and reflect the level of uncertainty/reliability of the forward acceleration aₓ and the different wheel speeds.

Additionally, or alternatively, in order to account for the effect of longitudinal slip, the signal processing system 502 may compute the prediction of the forward velocity (illustrated as v_{x,pred} in FIG. 5B) by (i) identifying and using the maximum value of the wheel velocities (V_{FL}, V_{FR}, V_{RL}, V_{RR}) if the forward acceleration is at or above a positive acceleration threshold value, (ii) identifying and using the minimum value of the wheel velocities (V_{FL}, V_{FR}, V_{RL}, V_{RR}) if the forward acceleration is at or below a negative acceleration threshold value (i.e., deceleration threshold value), and (iii) calculating a weighted mean of the wheel velocities if the forward acceleration is between the positive acceleration threshold value and the negative acceleration threshold value, where the weight assigned to each wheel velocity depends on the reliability of each wheel velocity measurement and its influence on the estimated velocity (e.g., each wheel’s tendency to slip).

In some embodiments, only a subset of the wheel velocities is used in the prediction of the forward velocity (e.g., the rear wheels only, the front wheels only, etc.). The predicted forward velocity is provided to the lateral velocity prediction block 502C and the kinematic filter block 502G, as shown in FIG. 5B.

### Lateral Velocity Prediction

At the lateral velocity prediction block 502C, the signal processing system 502 computes a predicted value of the vehicle lateral velocity to feedforward into the vehicle dynamics state estimation (e.g., velocity estimation performed by the kinematic filter block 502G).

One approach to lateral velocity prediction is a kinematic approach defined by the equation below:

$${υ}_{y} = {υ}_{x} \left(\frac{{l}_{r}}{{l}_{r} + {l}_{f}}\right) t a n \left(δ\right)$$

where, l_{f} and lᵣ are the distances from vehicle’s CG to front and rear axles, respectively. In some cases, this approximation is used for small values of vₓ and v_{y}.

Another approach to lateral velocity prediction is a dynamic approach using the bicycle model:

$$\left[\begin{matrix}{\dot{v}}_{y} \\ \ddot{ψ}\end{matrix}\right] = \frac{1}{{v}_{x}} \left[\begin{matrix}\frac{- 2 \left({C}_{f} + {C}_{r}\right)}{m} & \frac{2 \left({C}_{r} {l}_{r} - {C}_{f} {l}_{f}\right)}{m} \\ \frac{2 \left({C}_{r} {l}_{r} - {C}_{f} {l}_{f}\right)}{{l}_{z}} & \frac{- 2 \left({C}_{f} {l}_{f}^{2} + {C}_{r} {l}_{r}^{2}\right)}{{l}_{z}}\end{matrix}\right] \left[\begin{matrix}{v}_{y} \\ \dot{ψ}\end{matrix}\right] + \left[\begin{matrix}- {v}_{x} \dot{ψ} \\ 0\end{matrix}\right] + 2 {C}_{f} \left[\begin{matrix}\frac{1}{m} \\ \frac{{l}_{f}}{{l}_{z}}\end{matrix}\right] δ$$

where, m and l_{z} are the vehicle’s mass and yaw-moment of inertia, respectively. This model provides a good approximation for the lateral dynamics in the linear tire forces operating range.

Yet another approach to lateral velocity prediction is a kinematic approach in which the following are obtained using the lateral tire forces:

$$\begin{matrix}{υ}_{y} = - {l}_{f} \dot{ψ} + \left(δ - \frac{{F}_{y f}}{2 {C}_{f}}\right) {υ}_{x} \\ {υ}_{y} = {l}_{r} \dot{ψ} - \frac{{F}_{y r}}{2 {C}_{r}} {υ}_{x}\end{matrix}$$

where F_{yf} and F_{yr} denote the front/rear lateral forces, respectively. Here,

Yet another approach to lateral velocity prediction is a kinematic approach that is closely related to the approach presented above:

$${υ}_{y} = {l}_{r} \dot{ψ} - \frac{{υ}_{x}}{2 {C}_{r} \left({l}_{r} + {l}_{f}\right)} \left({l}_{f} m {a}_{y} - {I}_{z} \ddot{ψ}\right)$$

where ψ̈ is the acceleration of the yaw angle.

Yet another approach to lateral velocity prediction involves the following force and moment equilibrium equations (wind drag neglected):

$$\begin{matrix}m {a}_{y}^{8} = {F}_{y f} + {F}_{y r} \\ {J}_{z} {\dot{ω}}_{z} = {l}_{f} {F}_{y f} - {l}_{r} {F}_{y r}\end{matrix}$$

where m is the vehicle mass, F_{yf} and F_{yr} are the lateral forces at the front and rear axle respectively, and J_{z} is the vehicle moment of inertia with respect to the z-axis.

By multiplying the first equation by l_{f}, subtracting the second equation, and substituting F_{yr}, the signal processing system 502 can obtain:

$$\begin{matrix}{l}_{f} m {a}_{y}^{s} - {J}_{z} {\dot{ω}}_{z} = \left({l}_{f} + {l}_{r}\right) {F}_{y r} \\ = \left({l}_{f} + {l}_{r}\right) {c}_{a r} \left(\frac{{l}_{r} {ω}_{z}}{{v}_{x}} - \frac{{v}_{y}}{{v}_{x}}\right)\end{matrix}$$

By solving for v_{y}, the signal processing system 502 can obtain the following expression for predicting the lateral velocity:

$${v}_{y} = {l}_{r} {ω}_{z} - \frac{{l}_{f} m}{{c}_{a r} l} {a}_{y}^{s} {v}_{x} + \frac{{J}_{z}}{{c}_{a r} l} {\dot{ω}}_{z} {v}_{x}$$

where l = l_{f} + lᵣ and cₐᵣ is the rear tire cornering stiffness (also referred to as Cr herein).

In some cases, the estimated lateral velocity from block 502G using the lateral velocity predicted in the manner above can be more accurate because the above approach relies only on Cr (or Cₐᵣ in the equations above) and not Cf (e.g., in the event that Cf is not as accurate as Cr).

Although several approaches to lateral velocity prediction according to some embodiments are described herein, in other embodiments, a different approach to lateral velocity prediction is used.

### Prediction of Lateral and Normal Forces

At the lateral forces prediction block 502D and the normal forces prediction block 502E, the signal processing system 502 computes the predicted values of the lateral and normal forces, respectively. The lateral and normal forces can be computed using the sensor data (e.g., forward acceleration, lateral acceleration, steering angle, and yaw rate) and other predicted values (e.g., forward velocity prediction) from block 502B.

For example, the lateral force on the front axle (F_{yf}), the lateral force on the rear axle (F_{yr}), the normal force on the front axle (F_{zf}), and the normal force on the rear axle (F_{zr}) can be computed using the following equations (using the convention illustrated in FIG. 6C):

$${F}_{y f} = \frac{m {a}_{y} + {I}_{z} \ddot{ψ}}{\left({l}_{f} + {l}_{r}\right) c o s δ}$$

$${F}_{y r} = \frac{m {a}_{y} + {I}_{z} \ddot{ψ}}{{l}_{f} + {l}_{r}}$$

$$F {z}_{F} = {m}_{t o t} \left(\frac{g {l}_{r} - {a}_{x} {h}_{c g}}{{l}_{f} + {l}_{r}}\right)$$

$$F {z}_{R} = {m}_{t o t} \left(\frac{g {l}_{f} - {a}_{x} {h}_{c g}}{{l}_{f} + {l}_{r}}\right)$$

where h_{cg} represents the height of the CG of the vehicle, and m and mₜₒₜ represent the total mass of the vehicle.

In other embodiments, other known methods of computing the lateral and normal forces may be used.

### Cornering Stiffness Estimation

At the cornering stiffness estimation block 502F, the signal processing system 502 estimates the cornering stiffness of the front and rear tires. An example process of estimating the cornering stiffness values referred to herein is described below according to the convention illustrated in FIG. 6C.

### Estimation Approach

Based on the data collected on a testing device using global navigation satellite system (GNSS) and/or inertial navigation system (INS) (e.g., RT3000), predicted lateral force on front tires F_{yf} and rear tires F_{yr} can be calculated based on the moment balance and force balance equation on vehicle bicycle model:

$$\begin{matrix}m {a}_{y} = {F}_{y f} + {F}_{y r} \\ {I}_{z} \ddot{ψ} = {l}_{f} {F}_{y f} - {l}_{r} {F}_{y r}\end{matrix}$$

where a_{y} is the testing device measurement of the lateral acceleration transformed onto the center of gravity (CG) (e.g., actual CG or an estimated or predetermined CG).

In small RWA region, the lateral tire force can be expressed with linear relation with tire slip angle alpha_f and alpha_r:

$$\begin{matrix}{F}_{y f} = 2 {C}_{f} {a}_{f} \\ {F}_{y r} = 2 {C}_{r} {a}_{r} \\ {a}_{f} = δ - {θ}_{v f} \\ {a}_{r} = - {θ}_{v r}\end{matrix}$$

where delta is the road wheel angle (RWA) (also referred to herein as the steering angle) and in a small RWA region, the front and rear velocity angles (front and rear tire sideslip angles) can be approximated by:

$$\begin{matrix}{θ}_{v f} = \frac{\dot{y} + {l}_{f} \dot{ψ}}{{v}_{x}} \\ {θ}_{v r} = \frac{\dot{y} - {l}_{r} \dot{ψ}}{{v}_{x}}\end{matrix}$$

With the collected data, the signal processing system 502 can plot F_{yf} vs alpha_f and F_{yr} vs alpha_r, and use a linear fitting to identify the parameters Cf and Cr (cornering stiffness values). In some embodiments, the signal processing system 502 trims the data outside the linear region and focus on the small RWA region for the plot of F_{yf} vs alpha_f and F_{yr} vs alpha_r. Then, the signal processing system 502 does a linear fitting (y = a*x) for the plot of Fyf vs alpha_f and Fyr vs alpha_r to determine the parameters Cf and Cr.

To validate the determined values of Cf and Cr, the signal processing system 502 input the Cf and Cr values into the vehicle state estimator and compare the value of v_{y} predicted by integrating the dynamic bicycle model to the value of v_{y} predicted using the determined Cf and Cr values. In some embodiments, the signal processing system 502 determines whether the difference between the two values is below a threshold level, in which case the determined Cf and Cr values are validated. In other embodiments, the signal processing system 502 determines whether the difference between the two values is less than the difference between the two values if default Cf and Cr values different from the determined Cf and Cr values are used, in which case the determined Cf and Cr values are validated. As described herein, the signal processing system 502 may continuously or periodically update the Cf and Cr values (e.g., for use by other blocks of the signal processing system 502 or other systems).

### Vehicle State Estimation

At the kinematic filter block 502G, the signal processing system 502 performs vehicle state estimation using sensor data and any predicted or estimated variables inputted into block 502G. Vehicle dynamics (VD) state estimation is concerned with estimating a number of important signals needed to control the vehicle’s forward and lateral motion. A number of algorithms that may have been performed prior to the vehicle state estimation at block 502G include one or more of the following:
IMU (raw) data pre-processing and bias removal
Vehicle’s lateral force computation (front/rear axles)
Vehicle’s forward velocity/tire-speed fusing
Vehicle’s lateral velocity prediction
Tire cornering stiffness computation and update

The kinematic filter block 502G may include a recursive filter (e.g., kinematic Kalman filter (KF)) that can be used to perform the following tasks:
Estimate vₓ from its predicted value obtained from fusing the wheel speeds
Estimate v_{y}, pitch angle, and roll angle

One example model that can be used to implement the filter used in block 502G is the following kinematic model:

$$\begin{matrix}\left[\begin{matrix}{\dot{υ}}_{x} \\ {\dot{υ}}_{y} \\ {\dot{g}}_{x} \\ {\dot{g}}_{y}\end{matrix}\right] = \left[\begin{matrix}0 & \dot{ψ} & 1 & 0 \\ - \dot{ψ} & 0 & 0 & - 1 \\ 0 & 0 & 0 & 0 \\ 0 & 0 & 0 & 0\end{matrix}\right] \left[\begin{matrix}{υ}_{x} \\ {υ}_{y} \\ {g}_{x} \\ {g}_{y}\end{matrix}\right] + \left[\begin{matrix}{a}_{x} \\ {a}_{y} \\ 0 \\ 0\end{matrix}\right] \\ y = \left[\begin{matrix}1 & 0 & 0 & 0 \\ 0 & 1 & 0 & 0\end{matrix}\right] \left[\begin{matrix}{υ}_{x} \\ {υ}_{y} \\ {g}_{x} \\ {g}_{y}\end{matrix}\right] \\ {g}_{x} : = g s i n \left(θ\right) , {g}_{y} = g s i n \left(φ\right) c o s \left(θ\right) , g = 9.81 m / s e {c}^{2}\end{matrix}$$

On the left-hand side of the first equation is provided a matrix including the rates of change of the vehicle state variables (e.g., rate of change of the forward velocity vₓ, rate of change of the lateral velocity v_{y}, the rates of change of gₓ and g_{y}, which are defined in the third equation above and involve the pitch angle and the roll angle). On the righthand side of the first equation is provided a 4×4 matrix indicating the dynamics of the Kalman filter multiplied by a goal matrix (e.g., state vector) including the vehicle state variables to be estimated by the Kalman filter (e.g., and outputted to other systems in communication with the signal processing system 502) and also an input matrix including the input values (e.g., forward acceleration aₓ and lateral acceleration a_{y}). As indicated by the output signal y (second equation), the Kalman filter may output an output vector including the estimated forward velocity vₓ and the estimated forward velocity v_{y}. In some embodiments, the error rate of the Kalman filter is calculated as predicted values subtracted by the estimated values (e.g., (v_{x,pred} - v_{x_hat}, v_{y,pred} - v_{y_hat})), and the signal processing system 502 may determine that the Kalman filter is successfully estimating the estimated values based on the error rate being below a threshold value.

Although not part of this equation, the kinematic filter block 502G may also include calculation of tire side-slip angles alpha_front and alpha_rear. As one example, the front tire side-slip angles alpha_front and alpha_rear can be calculated using the following equations (using the convention illustrated in FIG. 6C):

$$\begin{matrix}{α}_{\text{f}} = δ - \text{arctan} \left(\left({\text{v}}_{\text{y\_estimate}} + {\text{l}}_{\text{f}} * \text{yaw} \text{rate}\right) / {\text{v}}_{\text{x\_estimate}}\right) \\ {α}_{\text{r}} = 0 \left(\text{no} \text{steering} \text{of} \text{rear} \text{wheels}\right)\end{matrix}$$

In some embodiments, the filter is implemented using an Euler discrete-time equivalent. As shown in the above kinematic model, the Kalman filter receives a predicted value of v_{y} (which can reduce noise when the vehicle is undergoing a straight-line motion (i.e., the yaw rate is zero or near zero). Doing so may improve the performance of the Kalman filter. Numerous different approaches to the lateral velocity prediction are described herein, and any of the predicted values of the lateral velocity can be fed into the Kalman filter to perform vehicle state estimation, including lateral velocity estimation.

### Outputting Vehicle State Variables to Other Systems

Using any combination of the variables determined or estimated at any of the blocks shown in FIG. 5B, the signal processing system 502 can continuously or periodically output vehicle state variables to one or more other systems of the vehicle (e.g., those illustrated in FIG. 4) so that such systems can utilize the vehicle state variables to perform their respective operations (e.g., control vehicle movement, perform other predictions or estimations, etc.). For example, such vehicle state variables can be used in lateral velocity and forward velocity control to cause the vehicle to follow a given trajectory, and to predict or estimate the curvature of the trajectory.

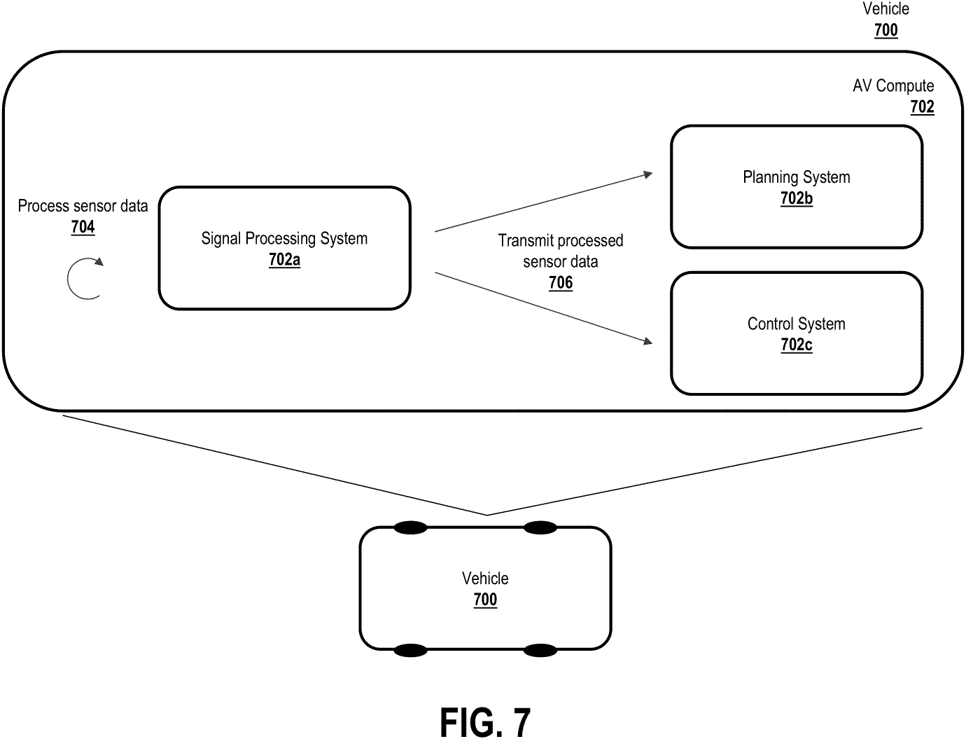

An example of such implementation is shown in FIG. 7. FIG. 7 shows is a diagram of an implementation 700 of a process for vehicle state estimation based on sensor data. In some embodiments, implementation 700 includes signal processing system 702a, planning system 702b, and control system 702c. In some embodiments, signal processing system 702a is the same as or similar to signal processing system 502. In some embodiments, planning system 702b is the same as or similar to planning system 404. In some embodiments, control system 702c is the same as or similar to control system 408.

As shown in FIG. 7, at 704, sensor data is processed by the signal processing system 702 (e.g., in a manner similar to that described with reference to FIGS. 5A and 5B), and at 706, the processed sensor data (which may include one or more of the vehicle state variables described with reference to FIGS. 5A and 5B) is transmitted by the signal processing system 702a (e.g., as done by the signal processing system 502 in FIGS. 5A and 5B) to the planning system 702b and the control system 702c. For example, the planning system 702b may use the processed sensor data to generate a route associated with the vehicle, and the control system 702c may use the processed sensor data to control an operation associated with the vehicle. Although systems 702b and 702c are illustrated as examples, fewer or more systems may be in communication with the signal processing system 702a and configured to receive the processed sensor data 706 for use in their respective tasks.

### Example Flowchart

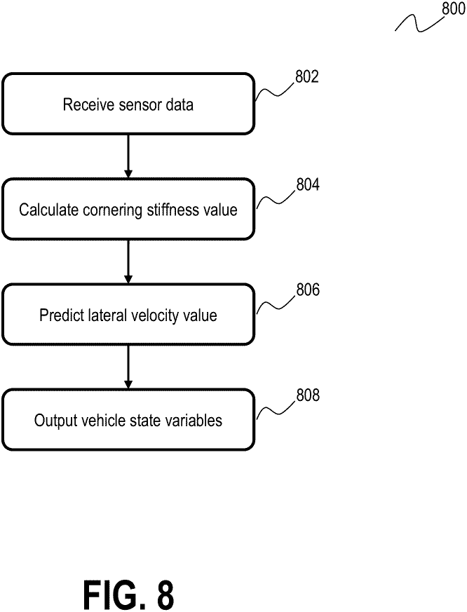

Referring now to FIG. 8, illustrated is a flowchart of a process 800 for vehicle state estimation based on sensor data. In some embodiments, one or more of the steps described with respect to process 800 are performed (e.g., completely, partially, and/or the like) by autonomous system 202. Additionally, or alternatively, in some embodiments one or more steps described with respect to process 800 are performed (e.g., completely, partially, and/or the like) by another device or group of devices separate from or including autonomous system 202. The flow diagram illustrated in FIG. 8 is provided for illustrative purposes only. It will be understood that one or more of the steps of the routine illustrated in FIG. 8 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 802, the signal processing system 502 receives the sensor data generated by one or more sensors provided on a vehicle. The sensors may include an IMU (e.g., 6-DoF IMU), a wheel speed sensor, a steering angle sensor, and the like. For example, the IMU may be located at the center of gravity of the vehicle or at a nearby location on the vehicle. In some embodiments, the sensors do not include a GPS sensor, or another sensor configured to detect forward or lateral velocities.

The sensor data generated by the one or more sensors may include one or more combinations of a forward acceleration value of the vehicle, a lateral acceleration value of the vehicle, a steering angle of the vehicle, a wheel rotational speed of each wheel (e.g., front left, front right, rear left, and rear right), and the like. In some embodiments, the signal processing system 502 performs one or more pre-processing operations (e.g., bias removal, signal fusion, signal transformation, etc.) on the sensor data before proceeding to block 804.

At block 804, the signal processing system 502 calculates, based at least in part on the steering angle and the lateral acceleration indicated by the sensor data, a cornering stiffness value associated with the vehicle. For example, the signal processing system 502 may calculate the cornering stiffness value according to the techniques described above in connection with block 502F.

At block 806, the signal processing system 502 predicts, based at least in part on the cornering stiffness value, a lateral velocity value associated with the vehicle. For example, the signal processing system 502 may predict the lateral velocity value according to the techniques described above in connection with block 502C.

At block 808, the signal processing system 502 outputs a set of vehicle state variables indicative of a current state of the vehicle at least by inputting the lateral velocity value into a recursive filter. For example, the set of vehicle state variables may include an estimated value of the lateral velocity determined by inputting the predicted lateral velocity into the recursive filter (e.g., a Kalman filter), along with the other variables shown in FIG. 5B. Additionally, the signal processing system 502 may also output the estimated cornering stiffness values, as shown in FIG. 5B.

In some embodiments, one or more of the vehicle state variables outputted by the signal processing system 502 are used to control the movement of the vehicle. In some of such embodiments, such controlling involves causing the vehicle to be autonomously controlled without a human driver’s assistance.

Although not illustrated in FIG. 8, the signal processing system 502 may continue to iteratively compute updated cornering stiffness values, compute updated predicted lateral velocity values, input the updated predicted lateral velocity values into the recursive filter, and output, to one or more external systems in communication with the signal processing system 502, the updated estimated vehicle dynamics state variables outputted by the recursive filter. For example, the updated cornering stiffness values may be computed using either the predicted lateral velocity determined at block 806 or the estimated lateral velocity determined at block 808. In some cases, an updated yaw rate received as part of the sensor data is also used to compute the updated cornering stiffness values. Additionally, or alternatively, updated versions of other predicted or estimated variables may be used to compute the updated cornering stiffness values (e.g., side-slip angles outputted by block 502G of FIG. 5B).

In some embodiments, the signal processing system 502 computes updated cornering stiffness values periodically or according to a predetermined schedule (e.g., every minute, every 10 minutes, every hour, etc.). In other embodiments, the signal processing system 502 computes updated cornering stiffness values in response to a change in one or more variables used to compute the cornering stiffness values (e.g., lateral forces, side-slip angles, etc.) or in response to a threshold amount of change to such variable(s) being detected.

It will be understood that the routine 800 can be repeated multiple times using different sensor data 506 and/or different updated parameters 512. In some cases, the signal processing system 502 may iteratively repeat the routine 800 as the vehicle travels and captures sensor data 506. Further, the signal processing system 502 may repeat the routine 800 for different sensors and/or different parameters of the sensors.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

1. A system, comprising:
at least one processor, and
a memory storing instructions thereon that, when executed by the at least one processor, cause the at least one processor to:
receive sensor data generated by the one or more sensors, the sensor data indicating at least a lateral acceleration value associated with a vehicle and a steering angle associated with the vehicle;
calculate, based on the steering angle and the lateral acceleration indicated by the sensor data, a cornering stiffness value associated with the vehicle;
predict, based on the cornering stiffness value, a lateral velocity value associated with the vehicle; and
provide a set of vehicle state variables indicative of a current state of the vehicle at least by inputting the lateral velocity value into a recursive filter.

2. The system of claim 1, wherein the at least one processor is further configured to cause a movement of the vehicle to be controlled using the set of vehicle state variables indicative of the current state of the vehicle.

3. The system of claim 1, wherein the at least one processor is further configured to cause a movement of the vehicle to be autonomously controlled using the set of vehicle state variables indicative of the current state of the vehicle, while forgoing reliance on a human driver’s assistance.

4. The system of claim 1, wherein the at least one processor is further configured to predict, based on the sensor data, a forward velocity value associated with the vehicle, and input the forward velocity value into the recursive filter.

5. The system of claim 1, wherein the at least one processor is further configured to predict, based on the sensor data, a lateral force value and a normal force value associated with the vehicle, and calculate the cornering stiffness value at least in part on the lateral force value and the normal force value.

6. The system of claim 1, wherein the at least one processor is further configured to determine that a bias removal process is to be performed on the sensor data, and perform the bias removal process on the sensor data prior to using the sensor data to calculate the cornering stiffness value.

7. The system of claim 1, wherein the at least one processor is further configured to update the cornering stiffness value based on the set of vehicle state variables.

8. The system of claim 7, wherein the at least one processor is further configured to update the lateral velocity value based on the updated cornering stiffness value.

9. The system of claim 8, wherein the at least one processor is further configured to update the set of vehicle state variables based on the updated lateral velocity value.

10. The system of claim 8, wherein the at least one processor is further configured to update the cornering stiffness value periodically and further update the lateral velocity value based on the updated cornering stiffness value.

11. The system of claim 1, wherein the cornering stiffness value comprises a front cornering stiffness value and a rear cornering stiffness value.

12. The system of claim 1, wherein the at least one processor is further configured to output the set of vehicle state variables to at least one of (i) a planning system, wherein the set of vehicle state variables output to the planning system is configured to cause the planning system to generate a route associated with the vehicle based on the set of vehicle state variables, (ii) a control system, wherein the set of vehicle state variables output to the control system is configured to cause the control system to control an operation associated with the vehicle based on the set of vehicle state variables, (iii) a localization system, wherein the set of vehicle state variables output to the localization system is configured to cause the localization system to determine a position associated with the vehicle based on the set of vehicle state variables, or (iv) a prediction system, wherein the set of vehicle state variables output to the prediction system is configured to cause the prediction system to determine a prediction associated with the vehicle based on the set of vehicle state variables.

13. The system of claim 1, wherein the at least one processor is further configured to predict the lateral velocity value associated with the vehicle using a kinematic bicycle model.

14. The system of claim 1, wherein the at least one processor is further configured to predict the lateral velocity value based on the sensor data generated by the one or more sensors that are each different from a Global Positioning System (GPS) sensor.

15. The system of claim 1, further comprising at least one sensor configured to generate the sensor data.

16. A method, comprising:
receiving the sensor data generated by the one or more sensors, the sensor data indicating at least a lateral acceleration value associated with a vehicle and a steering angle associated with the vehicle;
calculating, based on the steering angle and the lateral acceleration indicated by the sensor data, a cornering stiffness value associated with the vehicle;
predicting, based on the cornering stiffness value, a lateral velocity value associated with the vehicle; and
outputting a set of vehicle state variables indicative of a current state of the vehicle at least by inputting the lateral velocity value into a recursive filter.

17. The method of claim 16, further comprising:
updating the cornering stiffness value based on the set of vehicle state variables; and
updating the lateral velocity value based on the updated cornering stiffness value.

18. The method of claim 16, further updating the set of vehicle state variables based on the updated lateral velocity value.

19. At least one non-transitory storage media storing instructions that, when executed by a computing system comprising a processor, cause the computing system to:
receive the sensor data generated by the one or more sensors, the sensor data indicating at least a lateral acceleration value associated with a vehicle and a steering angle associated with the vehicle;
calculate, based on the steering angle and the lateral acceleration indicated by the sensor data, a cornering stiffness value associated with the vehicle;
predict, based on the cornering stiffness value, a lateral velocity value associated with the vehicle; and
output a set of vehicle state variables indicative of a current state of the vehicle at least by inputting the lateral velocity value into a recursive filter.

20. The at least one non-transitory storage media of claim 19, wherein the instructions, when executed by the computing system, further cause the computing system to:
update the cornering stiffness value based on the set of vehicle state variables;
update the lateral velocity value based on the updated cornering stiffness value; and
update the set of vehicle state variables based on the updated lateral velocity value.
